(19) United States
(12) Patent Application Publication
(10) Pub. No.: US 2016/0270046 A1
(43) Pub. Date: Sep. 15, 2016

(54) DATA-CARRIED CONTROL SIGNALING MODE

(71) Applicant: QUALCOMM Incorporated, San Diego, CA (US)

(72) Inventors: Jamie Menjay Lin, San Diego, CA (US); Jing Jiang, San Diego, CA (US); Krishna Kiran Mukkavilli, San Diego, CA (US); Tingfang Ji, San Diego, CA (US)

(21) Appl. No.: 15/048,629

(22) Filed: Feb. 19, 2016

Related U.S. Application Data
(60) Provisional application No. 62/133,345, filed on Mar. 14, 2015.

(51) Int. Cl. H04W 72/04; H04L 5/00

(52) U.S. Cl. CPC H04W 72/0406; H04L 5/0055

(57) ABSTRACT

The present disclosure provides a data-carried control signaling mode (DCM) for communication of control information and associated data and associated switching mechanism for switching between DCM and the known legacy control signaling mode (LCM). Associated methods, devices, and systems are disclosed. For example, in some implementations a method includes embedding control information into a data frame including associated data corresponding to the control information; jointly encoding the control information and the associated data; and jointly transmitting the control information and the associated data.

### CROSS REFERENCE TO RELATED APPLICATIONS

The present application claims priority to and the benefit of the U.S. Provisional Patent Application No. 62/133,345, filed Mar. 14, 2015, which is hereby incorporated by reference in its entirety.

### TECHNICAL FIELD

The present disclosure relates to communication networks, and more particularly to communication of control information and associated data between a base station and user equipment within a communication network. The present disclosure discloses a novel data-carried control signaling mode (DCM) for communication of control information and associated data. Also, the present disclosure discloses a novel switching mechanism to switch between the novel data-carried control signaling mode (DCM) and the known legacy control signaling mode (LCM).

### BACKGROUND

In conventional communication networks, the legacy control signaling mode (LCM) is used to communicate, i.e., to transmit and to receive, control information and associated data between a base station and a user equipment or a group of user equipments. In the LCM mode, the base station processes the control information and the associated data separately. That is, the control information and associated data are encoded independently with respect to each other, and are transmitted as separate units. For example, during downlink communication in a Long Term Evolution (LTE) communication network, the base station (or eNodeB) encodes the control information for transmission over the Physical Data Control Channel (PDCCH) to the user equipment. Also, the base station separately encodes the associated data for transmission over the Physical Data Shared Channel (PDSCH) to the user equipment. The base station then transmits the control information over PDCCH and separately transmits and the associated data over PDSCH within the same frame to the user equipment.

The user equipment decodes the encoded control information received over the PDCCH, and separately decodes the encoded associated data received over the PDSCH by using, for example, scheduling and grant information included in the control information. As such, in the LCM mode, the user equipment also processes the control information and the associated data separately. When decoding of the associated data is successful, the user equipment transmits an acknowledgment (ACK) message to the base station, and when the decoding of the associated data is unsuccessful, the user equipment transmits a negative acknowledgment (NACK) message to the base station. If the negative acknowledgment (NACK) message is received from the user equipment, the base station can employ a Hybrid Auto Repeat Request (HARQ) procedure to again process communication of the control information and the associated data separately, as previously discussed.

The LCM mode is inflexible in that the control information must always be communicated over a given channel (e.g., PDCCH). Also, in the LCM mode, the processing (e.g., encoding, transmission, reception, and decoding) of the control information must be separate from the processing (e.g., encoding, transmission, reception, and decoding) of the associated data. The above inflexibility along with the separate processing at the base station and the user equipment lead to inefficiencies within the communication network in terms of use of the available spectrum, processing complexity and latency, encoding/decoding efficiency, and link performance. To overcome the above shortcomings of the LCM mode, and to improve efficiency within the communication network, the present disclosure proposes a data-carried control signaling mode (DCM) and a switching mechanism to switch between the data-carried control signaling mode (DCM) and the legacy control signaling mode (LCM).

### SUMMARY

In one aspect of the disclosure, a method for wireless communication is provided that includes embedding, via a data-carried control mode (DCM) module of a wireless communication device, control information into a data frame including associated data corresponding to the control information; jointly encoding, via the DCM module, the control information and the associated data; and jointly transmitting, via an antenna, the control information and the associated data.

In an additional aspect of the disclosure, a wireless communication device is provided that includes a data-carried control signaling mode (DCM) module configured to: embed control information into a data frame including associated data corresponding to the control information; and jointly encode the control information and the associated data; and an antenna configured to jointly transmit the control information and the associated data.

In an additional aspect of the disclosure, a wireless communication device is provided that includes means for embedding control information into the data frame including associated data corresponding to the control information; means for jointly encoding the control information and the associated data; and means for jointly transmitting the control information and the associated data.

In an additional aspect of the disclosure, a method for wireless communication is provided that includes selecting, via a data-carried control mode (DCM) module of a first wireless communication device, a legacy control mode (LCM) as a default mode for communication with a second wireless communication device; encoding, via the DCM module of the first wireless communication device, first control information for transmission in the LCM; transmitting, via an antenna of the first wireless communication device, the first control information in the LCM over a control channel to the second wireless communication device; switching, via the DCM module of the first wireless communication device, to the DCM for communication with the second wireless communication device; jointly encoding, via the DCM module of the first wireless communication device, second control information and first associated data for transmission in the DCM, the first associated data corresponding to the first control information; and jointly transmitting, via the antenna of the first wireless communication device, the second control information and the first associated data in the DCM over a data channel.

In an additional aspect of the disclosure, a wireless communication device is provided that includes a data-carried control mode (DCM) module configured to: select a legacy control mode (LCM) as a default mode for communication with a second wireless communication device; encode first control information for transmission in the LCM; switch to DCM for communication with the second wireless communication device; and jointly encode second control information and first associated data for transmission in the DCM, the first associated data corresponding to the first control information; and an antenna in communication with the DCM module, the antenna configured to transmit the first control information in the LCM over a control channel, and to jointly transmit the second control information and the first associated data in the DCM over a data channel.

In an additional aspect of the disclosure, a wireless communication device is provided that includes means for selecting a legacy control mode (LCM) as a default mode for communication with a second wireless communication device; means for encoding first control information for transmission in the LCM; means for transmitting the first control information in the LCM over a control channel to the second wireless communication device; means for switching to a data-carried control mode (DCM) for communication with the second wireless communication device; means for jointly encoding second control information and first associated data for transmission in the DCM, the first associated data corresponding to the first control information; and means for jointly transmitting the second control information and the first associated data in the DCM over a data channel.

Additional aspects, features, and advantages of the present disclosure will become apparent from the following detailed description.

### BRIEF DESCRIPTION OF THE DRAWINGS

FIG. 1 illustrates an exemplary communication network according to various aspects of the present disclosure.

FIG. 2 illustrates exemplary block diagrams of a base station and a user equipment in communication with each other, according to various embodiments of the present disclosure.

FIGS. 3a-3d illustrate exemplary data frames according to various embodiments of the present disclosure.

FIG. 4 illustrates an exemplary method for switching between the LCM and DCM modes according to various embodiments of the present disclosure.

FIG. 5 illustrates another exemplary method for switching between the LCM and DCM modes according to various embodiments of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

The techniques described herein may be used for various wireless communication networks such as CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the wireless networks and radio technologies mentioned above as well as other wireless networks and radio technologies, such as a next generation (e.g., 5^{th} Generation (5G)) network.

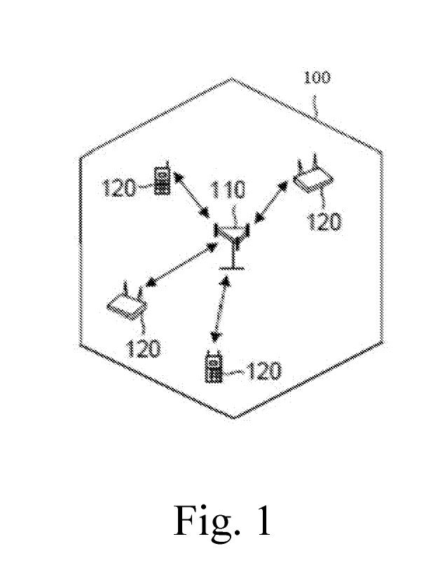

FIG. 1 illustrates a communication network 100 according to various aspects of the present disclosure. The communication network 100 may include elements such as base stations 110 and user equipments 120 in communication with each other. A base station 110 may include an evolved Node B (eNodeB) in the LTE context, for example. A base station 110 may also include a transceiver station or an access point. The user equipment 120 may be dispersed throughout the communication network 100, and may be stationary or mobile. A user equipment 120 may include a terminal, a mobile station, a subscriber unit, and the like. A user equipment 120 may also include a cellular phone, a smartphone, a personal digital assistant, a wireless modem, a laptop computer, a tablet computer, and the like. The communication network 100 is one example of a network to which various aspects of the disclosure apply.

As previously discussed, the inflexibility of having to communicate the control information over a given control channel (e.g., PDCCH) and the separate processing at the base station and the user equipment during communication of the control information and associated data lead to inefficiencies within the communication network. On the other hand, the present disclosure improves efficiency within the communication network by proposing (i) a data-carried control signaling mode (DCM), and (ii) a switching mechanism to switch between the novel data-carried control signaling mode (DCM) and the legacy control signaling mode (LCM).

The proposed DCM mode involves joint processing of the control information and associated data. In the DCM mode, each of the base station and the user equipment may conduct joint processing of the control information and the associated data. That is, the base station may conduct joint processing (e.g., encode, transmit, etc.) of the control information and the associated data, and the user equipment may conduct joint processing (e.g., receive, decode, etc.) of the control information and the associated data.

In various embodiments, the base station may embed the control information into the data frame that includes the associated data. The base station may then encode the control information and the associated data embedded within the data frame, thereby jointly encoding the control information and the associated data. Further, the base station may transmit the data frame including the control information and the associated data, thereby jointly transmitting the control information and the associated data. In various embodiments, the base station may transmit the data frame including the control information and the associated data over a data channel (e.g., PDSCH) to the user equipment. In this way, the DCM mode eliminates the need for the transmitter to encode and transmit the control information separately with respect to the associated data. As one can appreciate, the overall efficiency at the base station is improved because the amount of processing, complexity, and/or latency related to encoding and transmitting the control information can be significantly reduced.

The user equipment may receive the data frame including the control information and the associated data over the data channel (e.g., PDSCH), thereby jointly receiving the control information and the associated data. Further, the user equipment may decode the data frame including the control information and the associated data, thereby jointly decoding the control information and the associated data. By embedding the control information into the data frame that includes the associated data, the DCM mode eliminates the need for the receiver to search for and decode the control information in the control channel (e.g., PDCCH). As one can appreciate, the overall efficiency at the user equipment is improved because the amount of processing, complexity, and latency related to searching for and decoding the control information is significantly reduced.

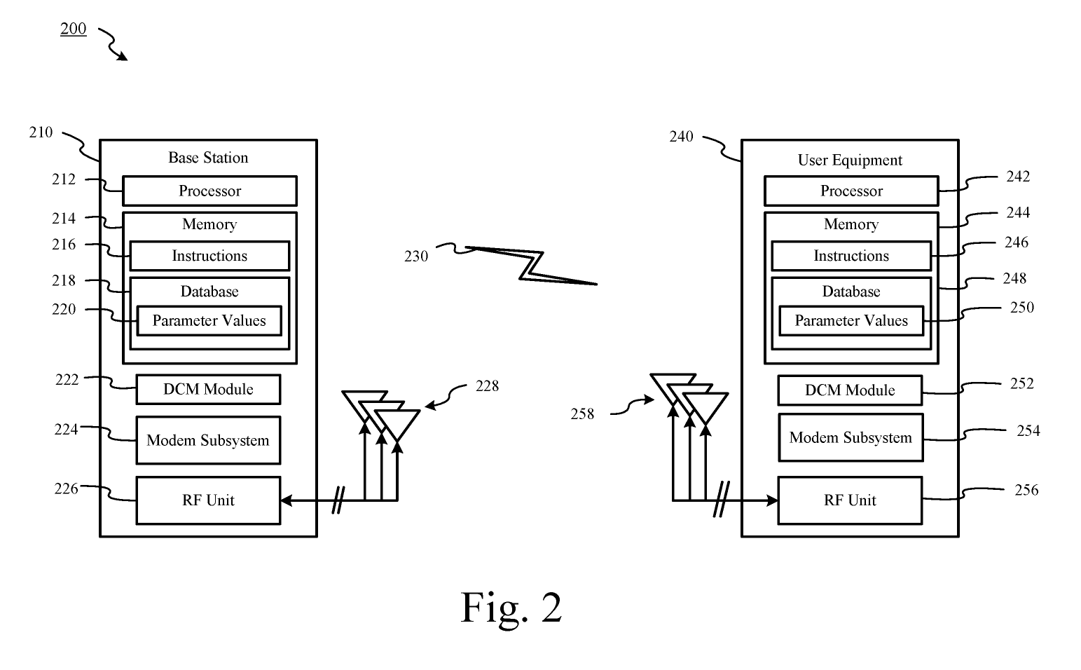

FIG. 2 shows exemplary block diagrams of a base station 210 and a user equipment 240, according to various embodiments of the present disclosure. The base station 210 and the user equipment 240 may be communicatively coupled via a wireless connection according to one or more protocols (e.g., a 3^{rd} generation (3G) protocol, an 802.11 protocol, an 802.15 protocol, a long term evolution (LTE) protocol, a 5^{th} generation (5G) protocol, etc.). The illustrated base station 210 may be the previously discussed base station 110, and the illustrated user equipment may be the previously discussed user equipments 120.

The user equipment 240 may be a mobile communication device (e.g., a smartphone, a cellular telephone, a personal digital assistant, etc.), a tablet computing device, a laptop computing device, a vehicle, a gaming console, a machine, a personal computing device, an e-reader device, a sensor device, another electronic device, or a combination of these devices that is operable to perform the operations described herein with respect to the user equipment 240. The user equipment 240 may include a processor 242, a memory 244, a DCM module 252, a modem subsystem 254, a radio frequency (RF) unit 256, and antenna element(s) 258. The RF unit 256 may be configured to process (e.g., perform analog to digital conversion, power amplification, etc.) of transmissions received via the antenna element(s) 258 (e.g., transmissions between the base station 210 and the user equipment 240) and the modem subsystem 254 may be configured to demodulate and/or decode the transmissions. Additionally, the modem subsystem 254, the RF unit 256, and the antenna element(s) 258 may also be used for transmissions originating from the user equipment 240 (e.g., uplink transmissions). The processor 242 may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein with reference to the user equipment 240 in connection with FIGS. 1-4.

The memory 244 may include a cache memory (e.g., a cache memory of the processor 242), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. The memory 244 may store instructions 246 and a database 248. The database 248 may include predetermined threshold parameter values 250 discussed below. The predetermined threshold parameter values 250 may include all or some of the types of information described in connection with the measurement and compares it of parameter values discussed below. However, the threshold parameter values 250 may be specific to the user equipment 240. That is, the threshold parameter values 250 may be different from the threshold parameters values 220 stored in the base station 210, and/or be different from any other threshold parameter values stored in other user equipments. The instructions 246 may include instructions that, when executed by the processor 242, cause the processor 242 to perform the operations described herein with reference to the user equipment 240 in connection with FIGS. 1-4.

The DCM module 252 may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein with reference to the user equipment 240 in connection with FIGS. 1-4.

The base station 210 may be an evolved Node B (eNodeB) (e.g., base station 110 of FIG. 1), a macro cell, a pico cell, a femto cell, a relay station, an access point, or another electronic device operable to perform the operations described herein with respect to the base station 210. The base station 210 may operate in accordance with one or more communication standards, such as a 3rd generation (3G) wireless communication standard, a 4th generation (4G) wireless communication standard, a long term evolution (LTE) wireless communication standard, an LTE-advanced wireless communication standard, or another wireless communication standard now known or later developed (e.g., a next generation network operating according to a 5G protocol).

As shown in FIG. 2, the base station 210 includes a processor 212, a memory 216, a DCM module 222, a modem subsystem 224, a radio frequency (RF) unit 226, and antenna elements 228. The processor 212 may include a CPU, a DSP, an ASIC, a controller, a FPGA device, another hardware device, a firmware device, or any combination thereof configured to perform the operations described herein with reference to the base station 210 in connection with FIGS. 1-4. The RF unit 226 may be configured to process (e.g., perform digital to analog conversion, power amplification, etc.) of transmissions originating from the base station 210 that may be transmitted via the antenna elements 228 (e.g., transmissions between the base station 210 and the user equipment 240) and the modem subsystem 224 may be configured to modulate and/or encode the transmissions according to a modulation and coding scheme (MCS) discussed below. Additionally, the modem subsystem 224, the RF unit 226, and the antenna elements 228 may also be used for receiving transmissions originating from the user equipment 240 (e.g., uplink transmissions).

The memory 214 may include a cache memory (e.g., a cache memory of the processor 412), RAM, MRAM, ROM, PROM, EPROM, EEPROM, flash memory, a solid state memory device, one or more hard disk drives, other forms of volatile and non-volatile memory, or a combination of different types of memory. The memory 214 may store instructions 216. The instructions 216 may include instructions that, when executed by the processor 212, cause the processor 212 to perform operations described in connection with FIGS. 1-4 of the present disclosure.

The memory 214 may store a database 218. In an aspect, the database 218 may be stored external to the base station 210. For example, the database 218 may be stored at memory device accessible to the base station 210 via a network, such as a backhaul network of a wireless communication system in which the base station 210 is operating. As another example, the base station 210 may be a pico cell or a femto cell operating within a coverage area provided by a macro cell, and the database 218 may be stored at a memory of the macro cell. In this example, the database 218 may be accessible via a connection (e.g., a wired or wireless connection) between the base station 210 and the macro cell.

The database 218, whether stored at the memory 214 or at another location accessible to the base station 210, may store predetermined threshold parameter values 220 discussed below. The predetermined threshold parameter values 220 may include information associated with the user equipment 240 and/or other mobile devices. The predetermined threshold parameter values 220 may include information associated with one or more parameters involved in the measuring and the comparison conducted by the base station 210, as discussed below. The predetermined threshold parameter values 220 may be respectively constructed for each different user equipment 240 (e.g., per SKU of the user equipment 240).

The DCM module 222 may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein with reference to the base station 210 in connection with FIGS. 1-4.

The user equipment 240 may support decoding of transmissions using one or more modulation and coding schemes (MCSs) (e.g., a low-density parity check (LDPC) coding scheme, a turbo coding scheme, a convolutional coding scheme, etc.), one or more transmission modes (e.g., single layer transmissions, multilayer transmissions, single user multiple-input multiple-output (SU-MIMO), multi-user multiple-input multiple-output (MU-MIMO), transmit diversity, beamforming, etc.), one or more carrier aggregation (CA) schemes, one or more duplex modes (e.g., time division duplexing (TDD) and/or frequency division duplexing (FDD)), one or more UE categories, one or more interference management techniques (e.g., enhanced inter-cell interference coordination (eICIC), network assisted interference cancellation (NAIC), etc.), one or more frame structures, other capabilities of the user equipment 240, or a combination thereof. Each of these capabilities of the user equipment 240 may be used by the base station 210 to configure the transmissions between the base station 210 and the user equipment 240, and the energy consumed by the user equipment 240 for processing the transmissions may vary based on the parameters selected by the base station 210 for configuring the transmissions between the base station 210 and the user equipment 240.

The modem subsystems 224, 254 may be configured to process the control information and associated data, for example, by modulating and/or encoding the data according to modulation and coding schemes (MCS) including, for example, a tail-biting convolution coding (TBCC) scheme, the Reed-Muller (RM) coding scheme, a low-density parity check (LDPC) coding scheme, a turbo coding scheme, a convolutional coding scheme, etc. The RF units 226, 256 may be configured to process (e.g., perform analog to digital conversion or digital to analog conversion, etc.) modulated/encoded data from the modem subsystems 224, 254 (on outbound transmissions) or of transmissions originating from another source. Although shown as being separate devices that are coupled together to enable communication with other devices, the modem subsystems 224, 254 and the RF units 226, 256 may be integrated together in respective transceivers.

The present disclosure proposes a plurality of ways of implementing the DCM mode. That is, the present disclosure proposes a plurality of ways of embedding the control information into the data frame that includes the associated data. In various embodiments, the control information may be included within a header of the data frame. In other embodiments, the control information may be concatenated with the associated data in the payload section of the data frame.

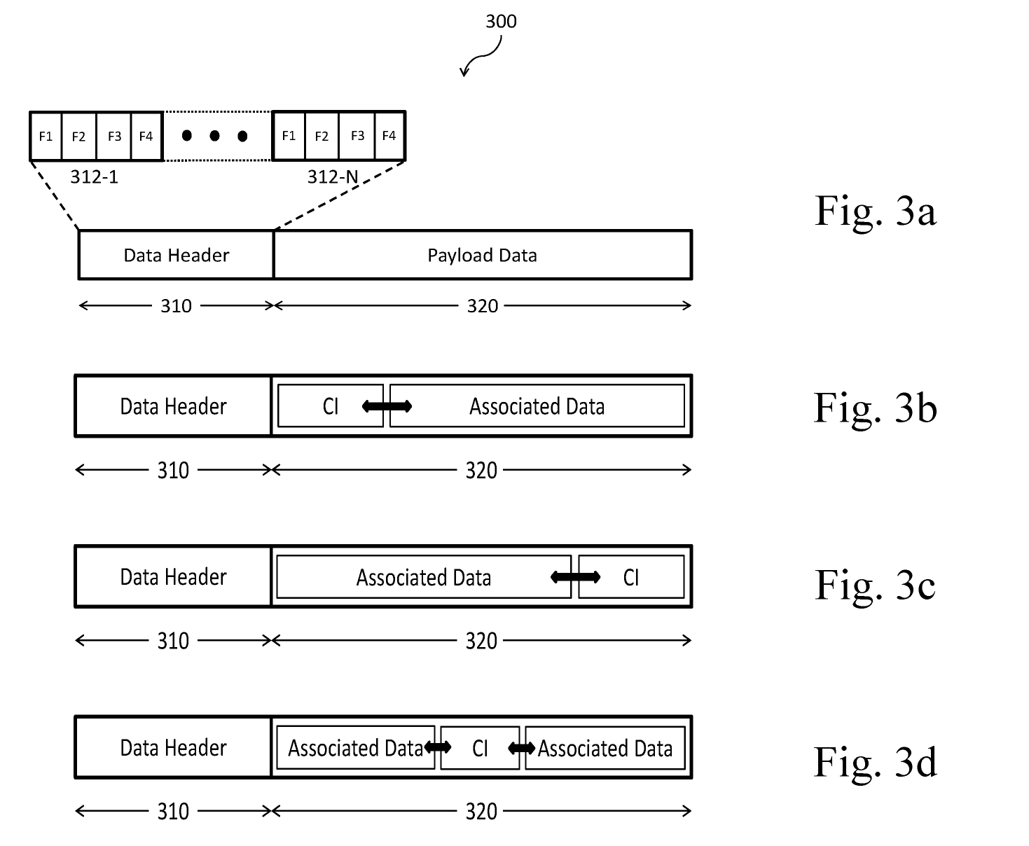

FIGS. 3a-3d show exemplary data frames 300 according to various embodiments of the present disclosure. Each data frame 300 may include a data header 310 and a payload section 320. The data header 310 may include a plurality of sub-headers 312-1 to 312-N. Each sub-header may further include a plurality of fields F1, F2, F3, F4. While four fields are shown for each sub-header, more or less fields can be included in other implementations. Each field may include bits of data providing information regarding the data frame 300. The payload section 320 may include the associated data.

The exemplary data frame 300 may be similar to a data frame used by the base station to transmit associated data over the data channel (e.g., PDSCH) in the LCM mode. In the legacy control signaling mode (LCM), the control information is transmitted over the control channel (e.g., PDCCH) and the data frame 300 including the associated data is transmitted over the data channel (e.g., PDSCH) to the user equipment.

On the other hand, the DCM mode is implemented by embedding the control information in the data frame 300. The control information may be embedded in the data frame 300 in various ways. For example, as shown in FIG. 3a, the control information may be included in the data header 310. In various embodiments, the control information may be included in one or more fields F1, F2, F3, F4 of the sub-headers 312-1 to 312-N. The control information may be translated into any unused data bits or unreserved data bits in one or more fields F1, F2, F3, F4 of the sub headers 312-1 to 312-N.

The control information may also be included within the payload section 320 of the data frame 300. For example, as shown in FIGS. 3b-3c, the base station 210 may concatenate the control information with the associated data in the payload section 320. In various embodiments, the control information may be included before (see FIG. 3b) or after (see FIG. 3c) the associated data. For instance, as shown in FIG. 3b, the control information may be linked to a beginning of the associated data or, as shown in FIG. 3c, the control information may be linked to an end of the associated data. Further, as shown in FIG. 3d, the control information may also be dispersed in between the associated data. In various embodiments, the control information may be included before and/or after and/or dispersed within the associated data.

Once the control information has been included in the data frame 300 as discussed above, the base station 210 may jointly encode the control information and the associated data included in the data frame 300. Further, the base station 210 may jointly transmit the encoded control information and the associated data in the data frame 300 over the data channel (e.g., PDSCH) to the user equipment 240. The user equipment 240 may jointly receive and decode the control information and the associated data included in the data frame 300.

In this way, the DCM mode eliminates the need for the base station 210 to separately encode and transmit the control information over the control channel (e.g., PDCCH), and improves the efficiency within the communication network. The DCM mode also enables achievement of additional improvements. One improvement is higher code performance for the control information. Typically, the control information is transmitted over the control channel and is, therefore, encoded using a weaker modulation scheme, such as the tail-biting convolution coding (TBCC) scheme or the Reed-Muller (RM) coding scheme. However, the associated data is typically transmitted over the data channel and is, therefore, encoded using a stronger modulation scheme, such as the low-density parity check (LDPC) coding scheme or the turbo coding scheme. In the DCM mode, the control information is included in the data frame and is, therefore, encoded using the stronger modulation schemes mentioned above. Further, the spectral efficiency of the control information can be improved because the control information is now transmitted over the data channel (e.g., PDSCH), which operates at a much higher modulation order compared to the control channel (e.g., PDCCH). Finally, including the control information within the data frame allows the base station to eliminate the need to allocate resources for processing of parity bits (e.g., CRC) that are typically added to the control information when the control information is transmitted over the control channel (e.g., PDCCH). These improvements enable increases in efficiency and reliability of the control information within the communication network.

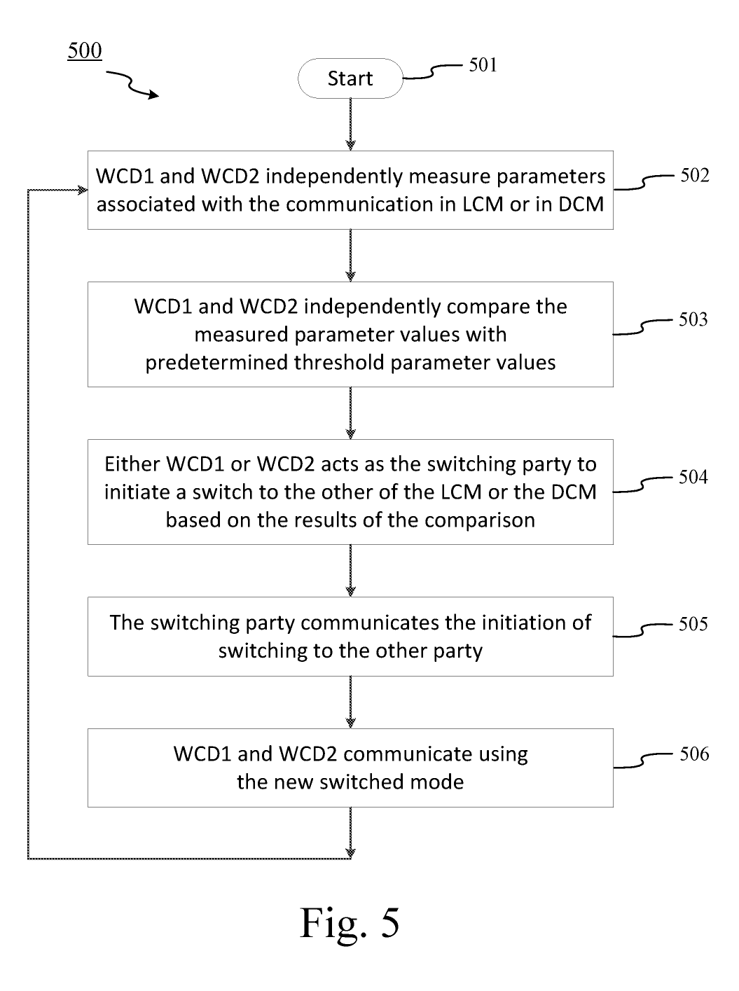

The present disclosure also proposes a flexible switching mechanism for the base station 210 and the user equipment 240 to switch between communicating in the LCM mode and the DCM mode. While communicating with each other, either the base station 210 or the user equipment 240 may act as the switching party to initiate the switching from the LCM mode to the DCM mode or from the DCM mode to the LCM mode. During or after initiating the switching to the other mode, the switching party may indicate the initiation to the other party, thereby informing the other party to also switch to the other mode. For example, as discussed later on with respect to FIG. 5, both the base station 210 and the user equipment 240 may independently measure parameter values associated with the communication between the base station 210 and the user equipment 240 in either the LCM mode or the DCM mode. Further, both the base station 210 and the user equipment 240 may independently compare the measured parameter values to respective predetermined threshold parameter values. Based on the results of the independent comparisons, either the base station 210 or the user equipment 240 may initiate a switch to the other of the LCM mode or the DCM mode. The threshold parameters values may be predetermined and stored in respective memories 204, 254 of the base station 210 and the user equipment 240. These parameters may include error rates associated with communication of control information and the associated data, number of re-transmissions encountered during communication, etc.

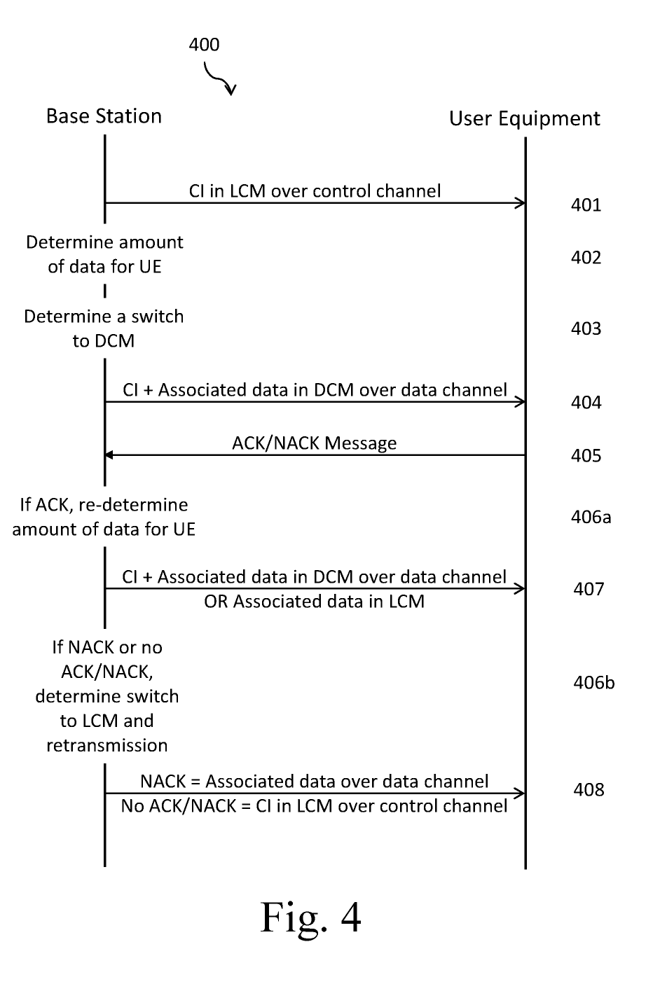

FIG. 4 illustrates a flow chart for an exemplary method 400 for switching between the LCM and DCM modes according to various embodiments of the present disclosure. When communication is established between the base station 210 and the user equipment 240, both the base station 210 and the user equipment 240 select the LCM mode as the default mode for communication.

At step 401, the base station 210 may transmit first control information (CI) in the LCM mode over the control channel (e.g., PDCCH) to the user equipment 240. The first control information (CI) may indicate to the user equipment 240 information regarding receiving and decoding first associated data transmitted during a first time interval. The user equipment 240 may receive the first control information (CI) in the LCM mode, and prepare to receive the first associated data during the first time interval. At step 402, the base station 210 may determine the amount of associated data buffered and/or allocated to be transmitted to the user equipment 240.

At step 403, the base station 210 may determine whether to initiate a switch to the DCM mode based on the amount of data determined in step 402. For example, if the base station 210 determines that there is enough buffered data to require transmission of second associated data during a second time interval, then the base station 210 may determine that the switch to the DCM mode should be initiated. At this time, the base station 210 may initiate a switch to the DCM mode and proceed to step 404. At step 404, the base station 210 may include second control information (CI) within the data frame including the first associated data, as previously discussed, and may transmit the second control information (CI) along with the first associated data in the data frame during the first time interval. The user equipment 240 may receive and decode the data frame to find that second control information (CI) is included in the data frame. The second control information (CI) in the data frame informs the user equipment 240 that second associated data will be transmitted during the second time interval. This serves as an indication to the user equipment 240 that the user equipment 240 should initiate a switch to the DCM mode, and prepare to receive the second associated data in the DCM mode during the second time interval. The method proceeds to step 405.

If the base station 210 determines at step 403 that the amount of buffered data does not require transmission of second associated data during a second time interval, then the base station 210 may determine that the switch to the DCM mode should not be initiated. The base station 210 may transmit the first associated data in the LCM mode during the first time interval to the user equipment 240. At this time, no further transmission from the base station 210 to the user equipment 240 is necessary.

At step 405, the base station 210 may receive a response message from the user equipment 240 in response to the transmission of the data frame in step 404, and may determine whether the response message is an acknowledgment message (ACK) or a negative acknowledgment message (NACK). At step 406a, if the base station 210 determines that the response message is an acknowledgment message (ACK), then the base station 210 may understand that the user equipment 240 has successfully received and decoded (i) the first control information (CI) transmitted during step 401 and (ii) the data frame including the second control information (CI) and the first associated data transmitted in step 404. At this time, the base station 210 can determine the amount of data buffered and allocated to be transmitted to the user equipment 240. The method proceeds to step 407.

If the base station 210 determines that there is enough buffered data to require transmission of third associated data during a third time interval, then, at step 407, the base station 210 may determine to continue communicating in the DCM mode, and may transmit a data frame including third control information (CI) and second associated data during the second time interval. However, if the base station 210 determines that the amount of buffered data does not require transmission of third associated data during the third time interval, then, at step 407, the base station 210 may switch to the LCM mode, and may transmit the second associated data in the LCM mode during the second time interval. At this time, no further transmission from the base station 210 to the user equipment 240 is necessary.

At step 406b, if the base station 210 determines that the response message is a negative acknowledgment (NACK), then the base station may understand that the user equipment 240 has successfully received and decoded the first control information (CI) transmitted during step 401, but not the data frame including the second control information (CI) and the first associated data transmitted in step 404. At this time, the base station 210 may determine that a switch to the LCM mode should be initiated, and that a data frame including the first associated data should be transmitted to the user equipment 240 over the data channel. In step 406b, the base station 210 may also determine that no response message was received from the user equipment 240, then the base station 210 may understand that the user equipment 240 failed to receive and decode both the first control information transmitted during step 401 and the data frame transmitted during step 404. At this time, the base station 210 may determine that a switch to the LCM mode should be initiated and that the first control information should be retransmitted to the user equipment 240 over the control channel (e.g., PDCCH).

At step 408, the base station 210 may initiate a switch to the LCM mode, and may transmit (i) the first associated data over the data channel if the response message was a negative acknowledgment (NACK) or (ii) the first control information over the control channel if no response message was received from the user equipment 240. In this way, the communication continues between the base station 210 and the user equipment 240.

The above exemplary method 400 describes that the base station 210 determines whether to initiate a switch to the DCM mode or the LCM mode based on the amount of data buffered and allocated to be transmitted to the user equipment 240. However, the base station 210 may determine whether to initiate a switch to the DCM mode or the LCM mode based on other considerations discussed below. Also, the above exemplary method 400 describes that the base station 210 determines whether to initiate a switch to the DCM mode or the LCM mode. However, as discussed previously, the user equipment 240 may also independently determine whether to initiate a switch to the DCM mode or the LCM mode, as discussed below.

FIG. 5 illustrates another exemplary method 500 for switching between the LCM and DCM modes according to various embodiments of the present disclosure. Both the base station 210 and the user equipment 240 may act as wireless communication devices (WCD) to perform the actions discussed herein with reference to the exemplary method 500 of FIG. 5.

The method starts at step 501. At step 502, the base station 210 and/or the user equipment 240 may independently measure parameter values associated with the communication between the base station 210 and the user equipment 240 in either the LCM mode or the DCM mode. At step 503, the base station 210 and/or the user equipment 240 may independently compare the measured parameter values to respective predetermined threshold parameter values. The threshold parameters values may be predetermined and stored in respective memories 204, 254 of the base station 210 and the user equipment 240. At step 504, based on the results of the independent comparison, the base station 210 and/or the user equipment 240 may act as the switching party to initiate a switch to the other of the LCM mode or the DCM mode. At step 505, the switching party indicates the initiation of the switching to the other party. At step 506, both the base station 210 and the user equipment 240 have switched to the other of the LCM mode or the DCM mode and communicate using the new switched mode. Following step 506, the method 500 returns to step 502.

The base station 210 and the user equipment 240 may continuously measure and compare the parameter values as discussed above. Alternatively, the base station 210 and the user equipment 240 may periodically measure and compare the parameter values as discussed above. In various embodiments, the periods during which the base station 210 and the user equipment 240 measure and compare the parameters values may vary. For example, when the base station 210 and the user equipment 240 are communicating in the DCM mode at high-efficiency, the periods for measuring and comparing the parameter values as discussed above may be longer. On the other hand, when the base station 210 and the user equipment 240 are communicating in the LCM mode at low efficiency, the periods for measuring and comparing the parameter values as discussed above may be shorter. In various embodiments, the base station 210 and the user equipment 240 may be programmed to vary the periods for measuring and comparing the parameter values automatically.

The measured and compared parameter values may include an error rate during decoding of the control information by the user equipment 240 in the LCM mode. If the error rate for decoding the control information is significantly lower than the predetermined error rate, then the base station 210 over the user equipment 240 may initiate a switch to the DCM mode. The measured and compared parameter values may also include a data throughput error rate of the associated data in the LCM mode or of the data frame 300 including the control information and the associated data in the DSM mode. If the error rate for decoding the associated data or the data frame 300 is significantly lower than the predetermined error rate, then the base station 210 or the user equipment 240 may initiate a switch to the DCM mode.

The base station 210 and the user equipment 240 may also measure and compare the number of re-transmissions encountered during communication. If the number of re-transmissions is higher than a predetermined or threshold number of re-transmissions, then the base station 210 or the user equipment 240 may initiate a switch to the LCM mode. The measured and compared parameter values may also include a modulation/coding scheme level and a data payload size. If the modulation/coding scheme level is lower than a predetermined level and the data payload size is greater than a predetermined payload size, then the base station 210 or the user equipment 240 may initiate a switch to the DCM mode. Other measured and compared parameter values may include channel quality indicator measurements. If the channel quality is better than a predetermined channel quality, then the base station 210 or the user agreement 250 may initiate a switch to the DCM mode. Finally, irrespective of the measured and compared values, either the base station 210 or the user equipment 240 may initiate a switch to the other of the DCM motor the LCM mode simply by requesting the switch.

In some instances, the base station 210 and the user equipment 240 may temporarily lose communication with each other for various reasons (e.g., a blind service spot encountered by the user equipment 240). In such instances, both the base station 210 and the user equipment 240 may default to the LCM mode to re-establish communication with each other.

In some implementations a wireless communication device is provided that includes: means for embedding control information into the data frame including associated data corresponding to the control information; means for jointly encoding the control information and the associated data; and means for jointly transmitting the control information and the associated data. The means for jointly transmitting may be configured to transmit the control information and the associated data over a data channel. The means for embedding may be configured to embed the control information into a header of the data frame and/or into a subheader of the header of the data frame. For example, the means for embedding may be configured to embed the control information by translating the control information into a data bit and including the data bit in a field of the subheader. The means for embedding may be configured to embed the control information into the data frame by concatenating the control information and the associated data such that an end of the control information is linked to a beginning of the associated data, a beginning of the control information is linked to an end of the associated data, and/or the control information is dispersed within the associated data.

In some implementations a computer readable medium having program code stored thereon is provided that includes: code for causing a computer operating in a network to embed, via a data-carried control mode (DCM) module of a wireless communication device, control information into a data frame including associated data corresponding to the control information; code for causing the computer operating in the network to jointly encode, via the DCM module, the control information and the associated data; and code for causing the computer operating in the network to jointly transmit, via an antenna, the control information and the associated data. The code for causing the computer to jointly transmit the control information and the associated data may cause the computer to jointly transmit the control information and the associated data over a data channel. The code for causing the computer to embed the control information into the data frame may cause the computer to embed the control information into a header of the data frame. The code for causing the computer to embed the control information into the data frame may cause the computer to embed the control information by translating the control information into a data bit and including the data bit in a field of a subheader of the data frame. The code for causing the computer to embed the control information into the data frame may cause the computer to concatenate the control information and the associated data such that: an end of the control information is linked to a beginning of the associated data; a beginning of the control information is linked to an end of the associated data; or the control information is dispersed within the associated data.

In some implementations a wireless communication device is provided that includes: a data-carried control mode (DCM) module configured to: select a legacy control mode (LCM) as a default mode for communication with a second wireless communication device; encode first control information for transmission in the LCM; switch to DCM for communication with the second wireless communication device; and jointly encode second control information and first associated data for transmission in the DCM, the first associated data corresponding to the first control information; and an antenna in communication with the DCM module, the antenna configured to transmit the first control information in the LCM over a control channel, and to jointly transmit the second control information and the first associated data in the DCM over a data channel. The antenna may be configured to jointly transmit the second control information and the first associated data during a first time interval, wherein information regarding the first time interval may be indicated by the first control information. The DCM module may be configured to determine an amount of associated data allocated for transmission to the second wireless communication device and to switch to the DCM based on the determined amount of associated data. The DCM module may be configured to jointly encode third control information and second associated data for transmission in the DCM, the second associated data corresponding to the second control information; and the antenna may be configured to jointly transmit the third control information and the second associated data in the DCM over the data channel. The antenna may be configured to jointly transmit the third control information and the second associated data during a second time interval, wherein information regarding the second time interval may be indicated by the second control information. The antenna may be configured to receive a response message from the second wireless communication device; and the DCM module may be configured to determine whether the response message is an acknowledgment message (ACK) or a negative acknowledgment message (NACK). The DCM module may be configured to re-determine the amount of associated data allocated for transmission to the second wireless communication device when it is determined that the response message is the acknowledgment message (ACK). The DCM module may be configured to switch to the LCM when it is determined that the response message is the negative acknowledgment message (NACK), and the antenna may be configured to retransmit the first associated data in the LCM over the data channel. The DCM module may be configured to switch to the LCM when it is determined that no response message was received from the second wireless communication device, and the antenna may be configured to retransmit the first control information in the LCM over the control channel. The DCM module may be configured to: measure a parameter related to the communication with the second wireless communication device; compare a value of the measured parameter to a predetermined threshold value of the parameter; and determine whether to switch from the LCM to the DCM or from the DCM to the LCM based on a result of the comparison. The wireless communication device may be a base station and/or a user equipment.

In some implementations a wireless communication device is provided that includes: means for selecting a legacy control mode (LCM) as a default mode for communication with a second wireless communication device; means for encoding first control information for transmission in the LCM; means for transmitting the first control information in the LCM over a control channel to the second wireless communication device; means for switching to a data-carried control mode (DCM) for communication with the second wireless communication device; means for jointly encoding second control information and first associated data for transmission in the DCM, the first associated data corresponding to the first control information; and means for jointly transmitting the second control information and the first associated data in the DCM over a data channel. The means for jointly transmitting may be configured to jointly transmit the second control information and the first associated data during a first time interval, wherein information regarding the first time interval is indicated by the first control information. The wireless communication device may further include means for determining an amount of associated data allocated for transmission to the second wireless communication device, wherein the means for switching switches to the DCM is based on the amount of associated data determined by the means for determining the amount of associated data. The wireless communication device may further include means for jointly encoding third control information and the second associated data for transmission in the DCM, the second associated data corresponding to the second control information; and means for jointly transmitting the third control information and the second associated data in the DCM over the data channel. The means for jointly transmitting may be configured to jointly transmit the third control information and the second associated data during a second time interval, wherein information regarding the second time interval is indicated by the second control information. The wireless communication device may further include means for receiving a response message from the second wireless communication device; and means for determining whether the response message is an acknowledgment message (ACK) or a negative acknowledgment message (NACK). The means for determining the amount of associated data may be configured to re-determine the amount of associated data allocated for transmission to the second wireless communication device when it is determined that the response message is the acknowledgment message (ACK). The means for switching may be configured to switch to the LCM when it is determined that the response message is the negative acknowledgment message (NACK), and the means for transmitting may be configured to re-transmit the first associated data in the LCM over the data channel. The means for switching may be configured to switch to the LCM when it is determined that no response message was received from the second wireless communication device, and the means for transmitting may be configured to re-transmit the first control information in the LCM over the control channel. The wireless communication device may further include means for measuring a parameter related to the communication between the base station and the second wireless communication device; and means for comparing a value of the measured parameter to a predetermined threshold value of the parameter, wherein the means for switching determines whether to switch from the LCM to the DCM or from the DCM to the LCM based on a result of the comparison.

In some implementations a computer readable medium having program code stored thereon is provided that includes: code for causing a computer operating in a network to select, via a data-carried control mode (DCM) module of a first wireless communication device, a legacy control mode (LCM) as a default mode for communication with a second wireless communication device; code for causing the computer operating in the network to encode, via the DCM module of the first wireless communication device, first control information for transmission in the LCM; code for causing the computer operating in the network to transmit, via an antenna of the first wireless communication device, the first control information in the LCM over a control channel to the second wireless communication device; code for causing the computer operating in the network to switch, via the DCM module of the first wireless communication device, to the DCM for communication with the second wireless communication device; code for causing the computer operating in the network to jointly encode, via the DCM module of the first wireless communication device, second control information and first associated data for transmission in the DCM, the first associated data corresponding to the first control information; and code for causing the computer operating in the network to jointly transmit, via the antenna of the first wireless communication device, the second control information and the first associated data in the DCM over a data channel. The code for causing the computer to jointly transmit may cause the computer to jointly transmit the second control information and the first associated data during a first time interval, information regarding the first time interval being indicated by the first control information. The computer readable medium may further include code for causing the computer operating in the network to determine an amount of associated data allocated for transmission to the second wireless communication device, wherein the switching to the DCM is based on the amount of associated data determined during the determining the amount of associated data. The computer readable medium may further include code for causing the computer operating in the network to jointly encode third control information and the second associated data for transmission in the DCM, the second associated data corresponding to the second control information; and code for causing the computer operating in the network to jointly transmit the third control information and the second associated data in the DCM over the data channel. The code for causing the computer to jointly transmit may cause the computer to jointly transmitting the third control information and the second associated data during a second time interval, information regarding the second time interval being indicated by the second control information. The computer readable medium may further include code for causing the computer operating in the network to receive a response message from the second wireless communication device; code for causing the computer operating in the network to determine whether the response message is an acknowledgment message (ACK) or a negative acknowledgment message (NACK); code for causing the computer operating in the network to re-determine the amount of associated data allocated for transmission to the second wireless communication device when it is determined that the response message is the acknowledgment message (ACK); and/or code for causing the computer operating in the network to switch to the LCM and re-transmit the first associated data in the LCM over the data channel when it is determined that the response message is the negative acknowledgment message (NACK). The computer readable medium may further include code for causing the computer operating in the network to switch to the LCM when it is determined that no response message was received from the second wireless communication device, and code for causing the computer operating in the network to re-transmit the first control information in the LCM over the control channel. The computer readable medium may further include code for causing the computer operating in the network to measure a parameter related to the communication between the first wireless communication device and the second wireless communication device; code for causing the computer operating in the network to compare a value of the measured parameter to a predetermined threshold value of the parameter; and code for causing the computer operating in the network to determine whether to switch from the LCM to the DCM or from the DCM to the LCM based on a result of the comparing.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular embodiments illustrated and described herein, as they are merely by way of some examples thereof, but rather, should be fully commensurate with that of the claims appended hereafter and their functional equivalents.

What is claimed is:

1. A method for wireless communication, comprising:
embedding, via a data-carried control mode (DCM) module of a wireless communication device, control information into a data frame including associated data corresponding to the control information;
jointly encoding, via the DCM module, the control information and the associated data; and
jointly transmitting, via an antenna, the control information and the associated data.

2. The method of claim 1, wherein the jointly transmitting includes jointly transmitting the control information and the associated data over a data channel.

3. The method of claim 1, wherein the embedding includes embedding the control information into a header of the data frame.

4. The method of claim 1, wherein the embedding includes embedding the control information by translating the control information into a data bit and including the data bit in a field of a subheader of the data frame.

5. The method of claim 1, wherein the embedding includes concatenating the control information and the associated data such that:
an end of the control information is linked to a beginning of the associated data;
a beginning of the control information is linked to an end of the associated data; or
the control information is dispersed within the associated data.

6. A wireless communication device, comprising:
a data-carried control signaling mode (DCM) module configured to:
embed control information into a data frame including associated data corresponding to the control information; and
jointly encode the control information and the associated data; and
an antenna configured to jointly transmit the control information and the associated data.

7. The wireless communication device of claim 6, wherein the antenna is configured to jointly transmit the control information and the associated data over a data channel.

8. The wireless communication device of claim 6, wherein the DCM module is configured to embed the control information into a header of the data frame.

9. The wireless communication device of claim 6, wherein the DCM module is configured to embed the control information by translating the control information into a data bit and include the data bit in a field of a subheader of the data frame.

10. The wireless communication device of claim 6, wherein the DCM module is configured to embed the control information into the data frame by concatenating the control information and the associated data such that:
an end of the control information is linked to a beginning of the associated data;
a beginning of the control information is linked to an end of the associated data; or
the control information is dispersed within the associated data.

11. The wireless communication device of claim 6, wherein the wireless communication device is a base station.

12. The wireless communication device of claim 6, wherein the wireless communication device is a user equipment.

13. A method for wireless communication, the method comprising:
selecting, via a data-carried control mode (DCM) module of a first wireless communication device, a legacy control mode (LCM) as a default mode for communication with a second wireless communication device;
encoding, via the DCM module of the first wireless communication device, first control information for transmission in the LCM;
transmitting, via an antenna of the first wireless communication device, the first control information in the LCM over a control channel to the second wireless communication device;
switching, via the DCM module of the first wireless communication device, to the DCM for communication with the second wireless communication device;
jointly encoding, via the DCM module of the first wireless communication device, second control information and first associated data for transmission in the DCM, the first associated data corresponding to the first control information; and
jointly transmitting, via the antenna of the first wireless communication device, the second control information and the first associated data in the DCM over a data channel.

14. The method of claim 13, wherein the jointly transmitting includes jointly transmitting the second control information and the first associated data during a first time interval, information regarding the first time interval being indicated by the first control information.

15. The method of claim 13, further comprising:
determining an amount of associated data allocated for transmission to the second wireless communication device, wherein
the switching to the DCM is based on the amount of associated data determined during the determining the amount of associated data.

16. The method of claim 13, further comprising:
jointly encoding third control information and the second associated data for transmission in the DCM, the second associated data corresponding to the second control information; and
jointly transmitting the third control information and the second associated data in the DCM over the data channel.

17. The method of claim 16, wherein the jointly transmitting includes jointly transmitting the third control information and the second associated data during a second time interval, information regarding the second time interval being indicated by the second control information.

18. The method of claim 13, further comprising:
receiving a response message from the second wireless communication device;
determining whether the response message is an acknowledgment message (ACK) or a negative acknowledgment message (NACK);
re-determining the amount of associated data allocated for transmission to the second wireless communication device when it is determined that the response message is the acknowledgment message (ACK); and
switching to the LCM and re-transmitting the first associated data in the LCM over the data channel when it is determined that the response message is the negative acknowledgment message (NACK).

19. The method of claim 13, further comprising:
switching to the LCM when it is determined that no response message was received from the second wireless communication device, and
re-transmitting the first control information in the LCM over the control channel.

20. The method of claim 13, further comprising:
measuring a parameter related to the communication between the first wireless communication device and the second wireless communication device;
comparing a value of the measured parameter to a predetermined threshold value of the parameter; and
determining whether to switch from the LCM to the DCM or from the DCM to the LCM based on a result of the comparing.
